(19) United States
(12) Patent Application Publication
(10) Pub. No.: US 2013/0282951 A1
(43) Pub. Date: Oct. 24, 2013

(54) SYSTEM AND METHOD FOR SECURE BOOTING AND DEBUGGING OF SOC DEVICES

(71) Applicants: Tom TsoWei Kuo, San Diego, CA (US); Azzedine Touzni, San Diego, CA (US)

(72) Inventors: Tom TsoWei Kuo, San Diego, CA (US); Azzedine Touzni, San Diego, CA (US)

(73) Assignee: QUALCOMM Incorporated, San Diego, CA (US)

(21) Appl. No.: 13/534,991

(22) Filed: Jun. 27, 2012

Related U.S. Application Data
(60) Provisional application No. 61/635,578, filed on Apr. 19, 2012.

(51) Int. Cl. G06F 12/14

(52) U.S. Cl. 711/102; 711/163; 711/E12.092

(57) ABSTRACT

Disclosed are systems, methods and computer program products for secure rebooting and debugging a peripheral subsystem of a system on a chip (SoC) device. According to one aspect of the method, when an application processor of the SoC device detects crash of the peripheral subsystem, the application processor loads a secure boot agent into SoC memory. The secure boot agent is configured to access a secure memory region of the peripheral subsystem containing memory dump data associated with the peripheral subsystem. The secure memory region is inaccessible to the application processor. The Secure boot agent encrypts the memory dump data in the secure memory region and opens the secure memory region for access to the application processor. The application processor accesses the secure memory region and collects the encrypted memory dump data. The application processor then forwards the encrypted memory dump data to a third party for debugging purposes.

### CLAIM OF PRIORITY UNDER 35 U.S.C. §119

The present application for patent claims priority to Provisional Application No. 61/635,578, entitled “Apparatus to enable debugging for peripheral subsystem SW within distributed secure boot SoC system” filed Apr. 19, 2012, and assigned to the assignee hereof and hereby expressly incorporated by reference herein.

### TECHNICAL FIELD

This disclosure relates generally to the field of computer systems and, more specifically, to the systems, methods and computer program products for secure booting and debugging of system on a chip (SoC) devices.

### BACKGROUND

Modern mobile communication devices, such as smartphones, tablets and netbooks, often use system on a chip (SoC) processors and similar types of integrated devices. A SoC processor is an integrated circuit in which various components, such as an application processor (e.g., CPU), memory subsystem (e.g., ROM, RAM), video/graphics subsystem (e.g., DSP, GPU), audio subsystem (e.g., DSP, ADC, DAC), power management subsystem, security subsystem (e.g., encryption, DRM), I/O subsystem (e.g., keyboard, touch screen), and wired and wireless connectivity subsystems (e.g., USB, GPS, Wi-Fi, GSM, CDMA, 4G LTE modems), are integrated on a single-chip substrate. SoC processors and devices are usually more compact, consume less power and have a lower cost and higher reliability than the conventional multi-chip systems.

However, as any other computer system, SoC devices are subject to crashes and other failures of its various peripheral subsystems (e.g., GPU or modem). During a crash of any of the peripheral subsystems of the SoC, the software (SW) of the subsystem is typically configured to perform a memory dump. A memory dump generally involves, but not limited to include, at least copying the processor cache dump, CPU register contents, copying the contents of hardware resources used by the crashed peripheral subsystem and copying the contents of the system memory used by the crashed peripheral subsystem to a separate memory location (e.g., RAM or HDD). The memory dump is typically followed by a reboot of the crashed peripheral subsystem. Memory dump data of the peripheral subsystem can then be accessed by the application processor of the SoC and sent for debugging to human analysts for the analysis and correction of problems related to the crash and for improvement of system's reliability.

In a secure SoC device, where different subsystems have different security levels and typically cannot access each other's resources without permission, the memory dump data of the crashed peripheral subsystem may be stored in a secure memory region. This secure memory region of the peripheral subsystem may not be accessible to the application processor in order to prevent possible attacks on the peripheral subsystem memory data from malicious applications, e.g., viruses. As a result, the application processor cannot access memory dump data to perform debugging and determine the root cause of the crash. Therefore, it is necessary to provide a mechanism by which the application processor can access the secure memory dump data without jeopardizing security of the peripheral subsystem.

### SUMMARY

The following presents a simplified summary of one or more aspects of the invention in order to provide a basic understanding of such aspects of the invention overall. This summary is not an extensive overview of all contemplated aspects of the invention, and is intended to neither identify key or critical elements of all aspects nor delineate the scope of any or all aspects. Its sole purpose is to present some concepts of one or more aspects in a simplified form as a prelude to the more detailed description that is presented later.

Disclosed are systems, methods and computer program products for secure rebooting and debugging a peripheral subsystem of a system on a chip (SoC) device. According to one aspect of the method, when an application processor of the SoC device detects crash of the peripheral subsystem, it loads a secure boot agent (SBA) into a memory of the SoC device. The SBA is configured to access a secure memory region of the peripheral subsystem that contains memory dump data associated with the peripheral subsystem. This secure memory region is inaccessible to the application processor. The SBA encrypts the memory dump data in the secure memory region and allows the application processor to access to the secure memory region of the peripheral subsystem containing the encrypted memory dump data. The application processor can then access the secure memory region and collects the encrypted memory dump data for the purpose of providing it to a third party for debugging.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates a block diagram of a system on a chip (SoC) processor of a mobile communication device in accordance with one example embodiment.

FIG. 2 illustrates a block diagram of a modified secure SoC processor of a mobile communication device in accordance with another example embodiment.

FIG. 3 is an illustration an example methodology of rebooting and debugging the secure SoC processor of a mobile communication device.

FIG. 4 depicts an example call flow of a process of rebooting and debugging a crashed modem subsystem of the secure SoC processor of a mobile communication device.

FIG. 5 illustrates an example methodology of encrypting memory dump data by in a secure boot agent (SBA) in the secure SoC processor of a mobile communication device.

FIG. 6 depicts an example security infrastructure of the secure SoC processor.

### DETAILED DESCRIPTION

Various aspects of the invention are described next with reference to the drawings. In the following description, for purposes of explanation, numerous specific details are set forth in order to provide a thorough understanding of one or more aspects. It may be evident, however, that such aspect(s) may be practiced without these specific details.

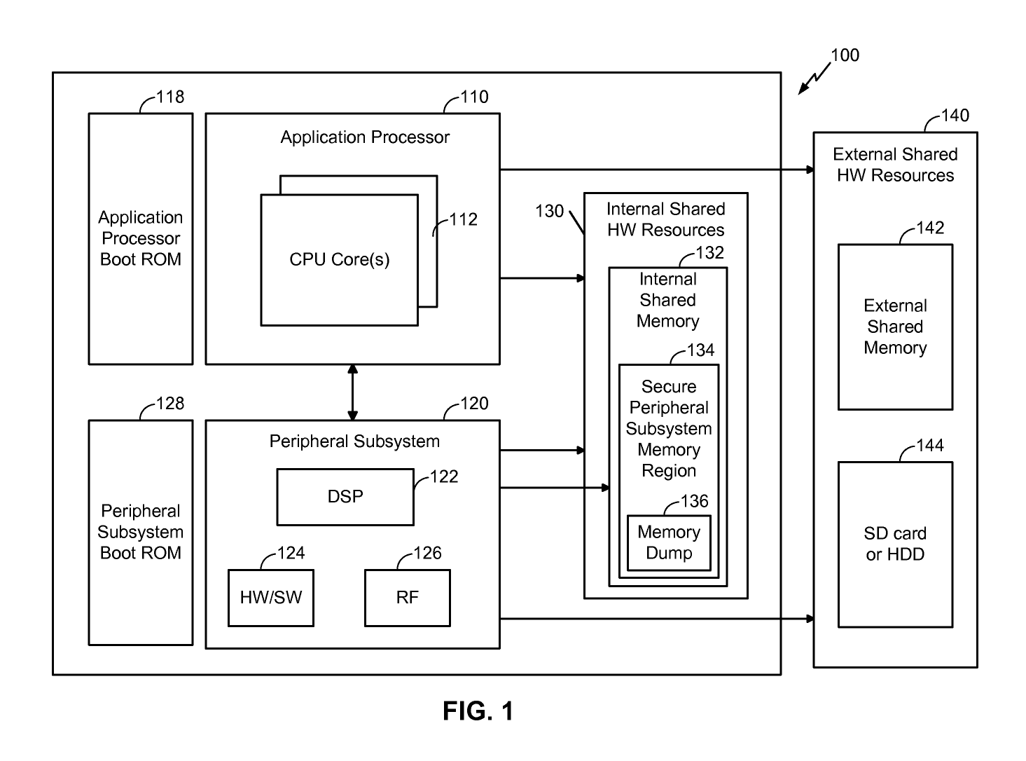

FIG. 1 illustrates a system on a chip (SoC) processor of a mobile communication device in accordance with one example embodiment of the invention. The SoC processor may be a Snapdragon™ processor manufactured by Qualcomm Corporation. The SoC processor 100 includes an application processor 110, which includes a multi-core CPU 112, such as a 1.5-1.7 GHz Dual-core x86 licensed or ARM licensed microprocessor. The application processor 110 typically controls operation of all components of the mobile communication device. In one aspect, the application processor 110 may include a boot ROM 118 that stores boot sequence instructions for the various components of SoC processor 100.

The SoC processor 100 further includes a plurality of different peripheral subsystems 120 controlled by the application processor 110. The peripheral subsystems 120 may include but not limited to a memory subsystem (e.g., ROM, RAM), video/graphics subsystem (e.g., DSP, GPU), audio subsystem (e.g., DSP, ADC, DAC), power management subsystem, security subsystem (e.g., encryption, DRM), I/O subsystem (e.g., keyboard, touchscreen), and wired and wireless connectivity subsystems (e.g., USB, GPS, Wi-Fi, GSM, CDMA, 4G LTE modems). A peripheral subsystem 120, such as a modem subsystem, may include a digital signal processor (DSP) 122, various hardware (HW) and software (SW) components 124, and various RF components 126. In one aspect, each peripheral subsystem 120 also includes a boot ROM 128 that stores a primary boot image (not shown) of the associated peripheral subsystems 120.

The SoC processor 100 further includes various internal shared HW resources 130, such as internal shared memory 132 (e.g. DDR SDRAM, DRAM, Flash memory), which is shared by the application processor 110 and various peripheral subsystems 120 to store various runtime data. In one aspect, components 110, 118, 120, 128 and 130 of the SoC processor 100 may be integrated on a single-chip substrate. The SoC processor 100 further includes various external shared HW resources 140, which may be located on a different chip substrate and communicate with the SoC processor 100 via a system bus (not shown). The external shared HW resources 140 may include, for example, an external shared memory 142 (e.g. DDR SDRAM, DRAM, Flash memory) and/or permanent data storage 144 (e.g., SD card, HDD), which are shared by the application processor 110 and various peripheral subsystems 120 to store various data, such as an OS, system files, programs, applications, user data, audio/video files, etc.

In one aspect, the SoC processor 100 is a secure system in which application processor 110 and peripheral subsystems 120, e.g., a modem subsystem, may have same security level (e.g., isolated security domains). In other words, the modem subsystem 120 cannot access secure regions of shared memory 132 or 142 used by the application processor 110 to store application data and other resources, and the application processor 110 cannot access secure regions of shared memory 132 or 142 used by the modem subsystem 120 to store modem data and other modem resources. This security configuration protects peripheral subsystem 120 from attacks by malicious applications, such as viruses, Trojans and worms, which may be run by the application processor 110, and also protects application processor 110 from attacks, e.g., network attacks, that may be carried out through the modem subsystem 120 by hackers.

When the mobile communication devices is turned on, the secure SoC processor 100 begins the system boot up process. Particularly, the application processor 110 access boot ROM 118 to retrieve boot instructions for the SoC processor 100, including boot sequence instructions for various peripheral subsystems 120. During booting of a peripheral subsystem 120, e.g., modem subsystem, application processor 110 first loads peripheral SW 124 into memory 132 and peripheral subsystem 120 boots itself based on the loaded SW 124 and a primary boot image stored in boot ROM 128. The SoC processor 100 identifies, during this initial boot stage, the resources that belong exclusively to the subsystem (e.g., modem). The resources that are pre-allocated during boot to the peripheral subsystem cannot be accessed by the CPU during normal runtime operations. In the case of CPU based on ARM licensed architecture, even the trust zone privileged mode is prevented from accessing the exclusive subsystem resource that are managed by the peripheral subsystem (e.g. clocks, memory, etc).

If the peripheral subsystem 120 crashes during operation, the peripheral SW 124 will automatically perform memory dump to a secure memory region 134 of the peripheral subsystem 120, and the application processor 110 will re-load the peripheral SW. However, the application processor 120 is not allowed to access the secure memory region 134 of the peripheral subsystem 120, and cannot view the memory dump data 136 stored therein in order to assess the root cause of the crash. Alternatively, the memory dump may be performed to a secure memory region of the peripheral subsystem in the external shared memory 142 or in the permanent data storage 144, such as a Secure Digital (SD) card or Hard Disk Drive (HDD).

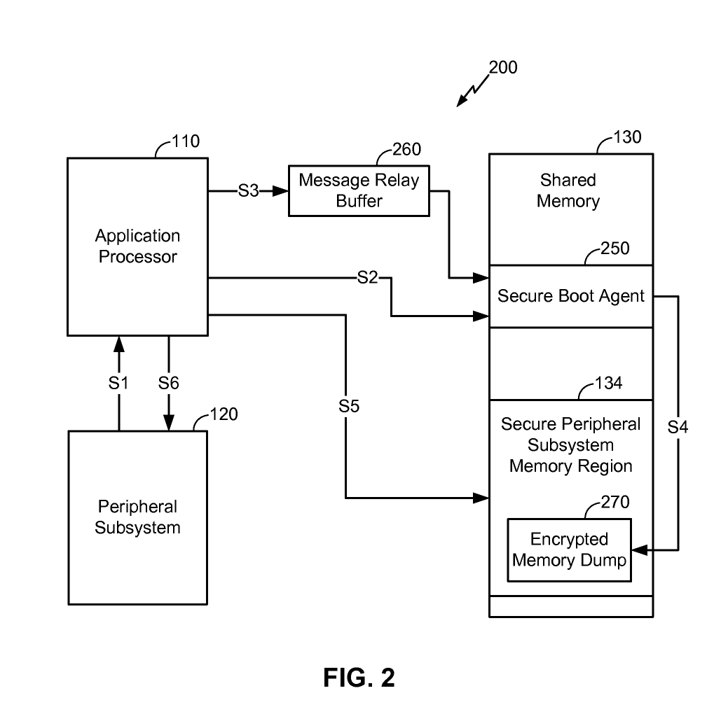

To overcome this problem, the SoC processor 100 may be modified as shown in FIG. 2. The modified SoC processor 200 includes two new components: a secure boot agent (SBA) 250 and a message relay buffer 260. SBA 250 is a program or script that may be stored as a secondary boot image in the system storage, such as memory 142 or SD/HDD 144, which is not part of peripheral system boot ROM 128 or peripheral SW 124. In one aspect, SBA 250 may be loaded into system memory 132 by the application processor 110 after crash of the peripheral subsystem 120. In another aspect, SBA 250 may be loaded into system memory 132 by the peripheral subsystem 120 during boot up process. SBA 250 may have access to the secure memory region of the peripheral subsystem 120, which is not accessible by the application processor 110. Once SBA 250 is loaded, the application processor 110 may use message relay buffer 260 to send messages to the SBA 250 with instruction to perform different tasks. For example, application processor 110 may instruct SBA 250 to encrypt memory dump data 136 stored in the secure memory region 134 of the peripheral subsystem 120. For that purpose, SBA 250 may contain various security algorithms and root keys for encrypting memory dump data 136 and generating encrypted memory dump 270. Once the memory dump 136 is encrypted, SBA 250 may allow application processor 110 to access (e.g., for a limited time) the encrypted memory dump data 270 in the secure memory region 134 for purpose of providing the encrypted memory dump 270 to a third party for debugging. For security purposes, the application processor 110 cannot decrypt the encrypted memory dump data 270 and can only forward it to a third party, e.g., a security company, for debugging purposes.

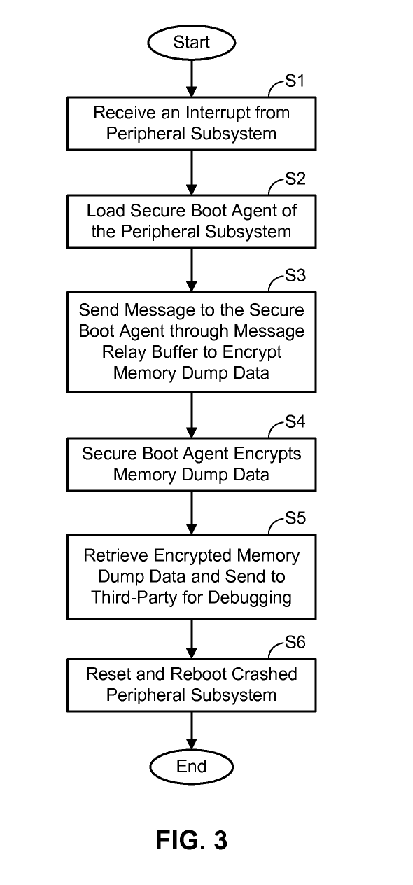

Operation of the modified SoC processor 200 is described next with reference to FIGS. 2 and 3. At step S1, the application processor 110 receives an interrupt from the peripheral subsystem 120 indicating crash of the peripheral subsystem. At step S2, the application processor 110 locates and loads the SBA 250 to the memory 130. At step S3, the application processor 110 sends a message via message relay buffer 260 to the SBA 250 with instructions to encrypt memory dump data 136 stored in the secure memory region 134 of the peripheral subsystem 120. At step S4, the SBA 250 reads instructions from the message relay buffer 260, encrypts memory dump data 136 in the in the secure memory region 134 of the peripheral subsystem 120, and opens up the secure memory region 134 for access by the application processor 110. At step S5, the application processor 110 retrieves encrypted memory dump data 270 from the secure memory region 134 and forwards it to the third party for debugging. At step S6, the application processor 110 resets and reboots the peripheral subsystem 120.

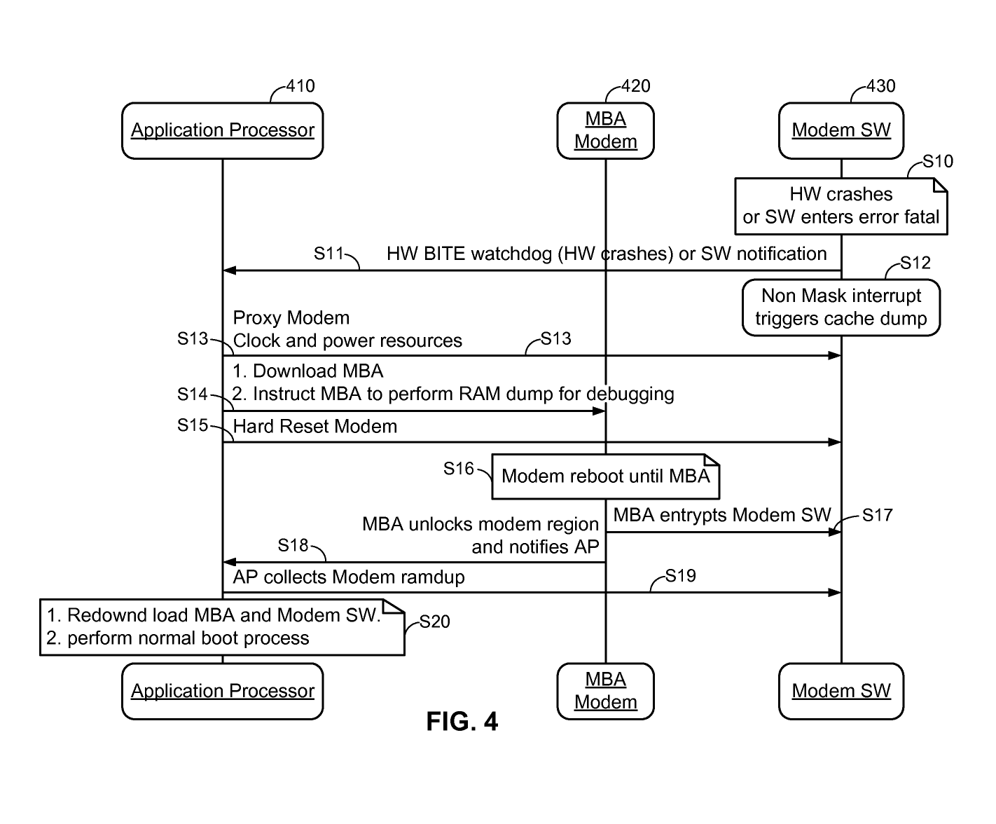

FIG. 4 depicts an example call flow of a method of rebooting and debugging of a crashed modem subsystem of a secure SoC device implemented using techniques and methodologies described herein. In the given example, the secure boot agent (SBA) is referenced as a modem boot agent (MBA) 420. It should be noted that the application processor 410 and the modem subsystem 430 are assigned to isolated security domains, which have the same security privileges. Therefore, the application processor 410 and the modem subsystem 430 have access to shared HW resources 130, such as internal shared memory 132. The MBA 420 and the modem subsystem 430 may have the highest security privileges in the SoC device to access other resources yet preventing access to each other's exclusive resources.

With reference to FIG. 4, a method for rebooting and debugging a modem subsystem of a SoC device begins at step S10, when the modem HW crashes or modem SW enters fatal error. At step S11, a modem SW or HW watchdog timer issues a notification to the application processor 410 that modem SW or HW has crashed. At step S12, the non maskable interrupt triggers modem SW 430 to perform memory dump. At step S13, the application processor 410 takes control over modem clock and power resources. At step S14, the application processor 410 loads MBA 420 into system memory and instructs MBA 420 to encrypt modem's memory dump data. At step S15, application processor 410, loads and resets modem SW 430. At step S16, modem reboots. At step S17, MBA 420 encrypts modem's memory dump data. At step S18, MBA 420 unlocks secure modem memory region and notifies the application processor 410 that the secure modem memory region is accessible for reading. At step S19, the application processor 410 accesses the unlocked secure modem memory region and collects encrypted memory dump data stored therein, and forwards it to a third party for purpose of debugging of the memory dump data. At step S20, the application processor 410 may re-download the MBA 420 and modem SW 430 and perform a normal modem boot process.

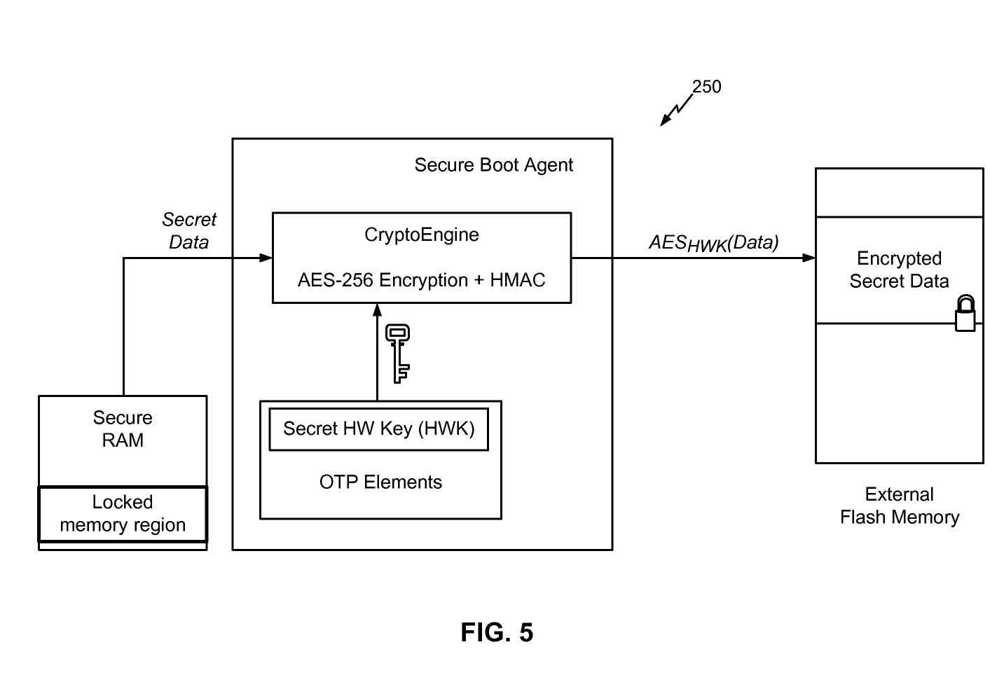

FIG. 5 illustrates an example methodology of encrypting memory dump data by in the secure boot agent. Once loaded, the SBA 250 may access secure memory region in the internal memory 132 that stores memory dump data 136. In one aspect, the SBA 250 uses a crypto engine to encrypt memory dump data 136. In one aspect, the crypto engine may perform AES-256 Encryption and HMAC (Hash-based Message Authentication Code) using a secret HW key (HWK). Other encryption techniques may be used in different aspects based, e.g., on processing capacity and security needs of the SoC device. The encrypted memory dump data 270 is then stored to the internal memory 132, external memory 142 or data storage 144 for access by the application processor. The encrypted memory dump data 270 is then accessed by the application processor 110 and provided to a third party for debugging purposes.

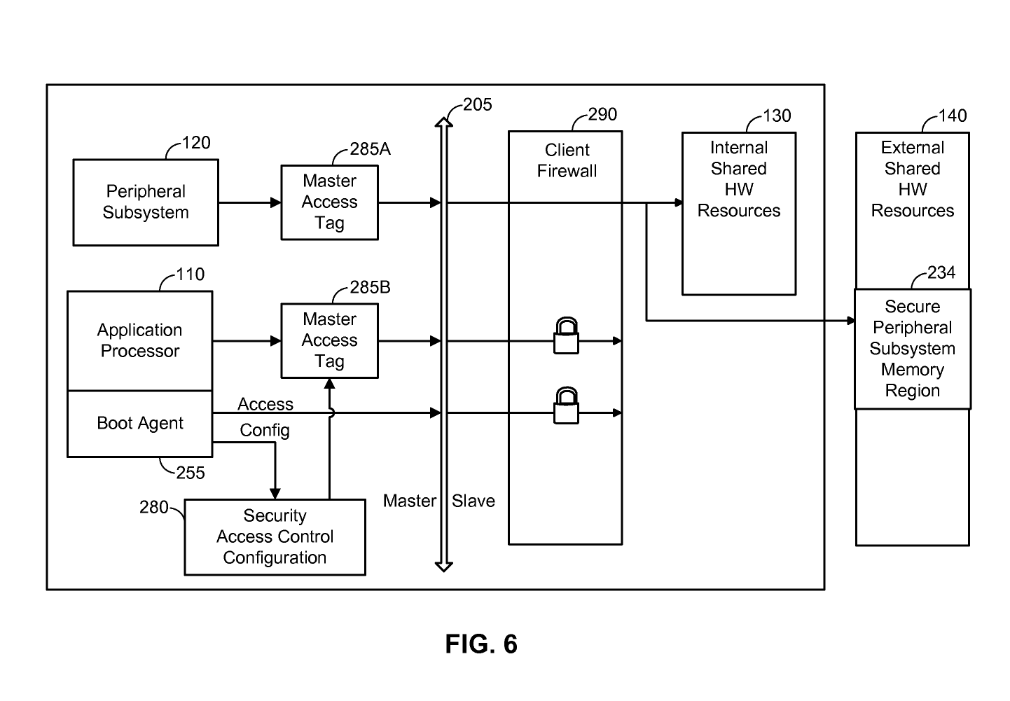

FIG. 6 depicts an example security infrastructure of the secure SoC processor that prevents direct access by the booting entity, e.g., application processor, to peripheral subsystems, e.g., modem subsystem, during system initialization. As explained above, application processor 110 and peripheral subsystem 120 may have the same security level, e.g., isolated security domains. The security levels of various system components are specified by the security access control configuration 280. In one aspect, the application processor 110 may include a boot agent 255 (which may be different from the SBA 250) that initializes in the security access control configuration 280 a set of protected peripheral subsystem resources to be removed from a set of resources accessible by the application processor 110 during normal mode of operation. For example, boot agent 255 may initialize security access control configuration 208, so that the application processor 110 cannot access modem data and modem resources. Once the shared resource ownership is given to the peripheral subsystem 120 by the application processor 110, the peripheral subsystem 120 may configure its secure resources via its own boot agent, such as a secure boot agent 250 described above.

The access to the shared resources (by modem 120 and application processor 110) may be controlled by a set of Secure Access Control tags 285A and 285B and firewall(s) 290. Master access tag 285 is a HW scheme that maps the origin of given transaction in the system to an access authority level. For example, application processor 110 will have level authority level 0, and a modem subsystem and power management subsystem will have authority level 1, etc. Client firewall 290 determines if the entity that wants to access the resource (example copy/read data in a specific memory location) has the appropriate authority to do so. For example, application processor 110 and modem subsystem may be authorized to access a certain secure region 234 in external memory 140, but power management subsystem is not.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Moreover, various aspects or features described herein can be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk drive, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blue-ray disc where disks usually reproduce data magnetically, while discs usually reproduce data optically with lasers. Combinations of the above should also be included within the scope of computer-readable media.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

1. A method for rebooting and debugging a peripheral subsystem of a system on a chip (SoC) device, the method comprising:
detecting, by an application processor of the SoC device, crash of the peripheral subsystem;
loading a secure boot agent into a memory of the SoC device, the agent configured to:
access a secure memory region of the peripheral subsystem containing memory dump data associated with the peripheral subsystem, wherein the secure memory region is inaccessible to the application processor;
encrypt the memory dump data in the secure memory region; and
allow the application processor to access to the secure memory region of the peripheral subsystem containing the encrypted memory dump data;
accessing, by the application processor, the secure memory region of the peripheral subsystem;
collecting, by the application processor, the encrypted memory dump data;
providing, by the application processor, the encrypted memory dump data, without decrypting the encrypted memory dump data, to a third party for debugging purposes; and
rebooting, by the application processor, the peripheral subsystem of the SoC device.

2. The method of claim 1, wherein loading a secure boot agent includes one of:
loading, by the application processor, the secure boot agent from a storage; and
loading, by the peripheral subsystem, the secure boot agent from the storage.

3. The method of claim 1, further comprising:
initializing, by the application processor, a set of protected peripheral subsystem resources to be remove from a set of resources accessible by the application processor during normal mode of operation.

4. The method of claim 1, wherein loading the secure boot agent, further includes:
providing a message relay buffer between the application processor and the secure boot agent; and
sending, by the application processor, a message to the secure boot agent via the message relay buffer instructing the secure boot agent to encrypt the memory dump data.

5. The method of claim 1, wherein rebooting, by the application processor, a peripheral subsystem includes: booting a primary boot image of peripheral software from a read only memory (ROM) of the peripheral subsystem.

6. The method of claim 1, wherein detecting, by an application processor of the SoC device, crash of the peripheral subsystem further includes: taking, by the application processor, control over a power source and a clock source to the peripheral subsystem.

7. The method of claim 1, wherein the secure boot agent, contains an encryption algorithm and a root key for encrypting peripheral data before allowing access to the secure memory region of the peripheral subsystem to the application processor.

8. The method of claim 1, wherein the peripheral subsystem includes one or more of a modem subsystem, a memory subsystem, video/graphics subsystem, audio subsystem, power management subsystem, security subsystem, and I/O subsystem.

9. A system on a chip (SoC) device comprising:
an application processor, a memory and at least one peripheral subsystem,
wherein the application processor is configured to:
detect crash of the at least one peripheral subsystem;
load a secure boot agent into the memory, the agent configured to:
access a secure memory region of the peripheral subsystem containing memory dump data associated with the peripheral subsystem, wherein the secure memory region is inaccessible to the application processor;
encrypt the memory dump data in the secure memory region; and
allow the application processor to access to the secure memory region of the peripheral subsystem containing the encrypted memory dump data;
access the secure memory region of the peripheral subsystem;
collect the encrypted memory dump data from the secure memory region;
provide the encrypted memory dump data, without decrypting the encrypted memory dump data, to a third party for debugging purposes; and
reboot the peripheral subsystem of the SoC device.

10. The system of claim 9, wherein the application processor further configured to:
initialize a set of protected peripheral subsystem resources to be remove from a set of resources accessible by the application processor during normal mode of operation.

11. The system of claim 9, further comprising:
a message relay buffer between the application processor and the secure boot agent used by the application processor to send messages to the secure boot agent instructing the secure boot agent to encrypt the memory dump data in the secure memory region.

12. The system of claim 9, wherein to reboot a peripheral subsystem, the application processor further configured to boot a primary boot image of peripheral software from a read only memory (ROM) of the peripheral subsystem.

13. The system of claim 9, wherein loading, by the application processor, the secure boot agent includes loading the secure boot agent from a storage into the memory.

14. The system of claim 9, wherein to detect crash of the peripheral subsystem, the application processor further configured to take control over a power source and a clock source to the peripheral subsystem.

15. The system of claim 9, wherein the secure boot agent, contains an encryption algorithm and a root key for encrypting peripheral data before allowing access to the secure memory region of the peripheral subsystem to the application processor.

16. The system of claim 9, wherein the peripheral subsystem includes one or more of a modem subsystem, a memory subsystem, video/graphics subsystem, audio subsystem, power management subsystem, security subsystem, and I/O subsystem.

17. An apparatus for rebooting and debugging a peripheral subsystem of a system on a chip (SoC) device, apparatus comprising:
means for detecting crash of the peripheral subsystem;
means for accessing a secure memory region of the peripheral subsystem containing memory dump data associated with the peripheral subsystem;
means for encrypting the memory dump data in the secure memory region;
means for allowing access to the secure memory region of the peripheral subsystem containing the encrypted memory dump data;
means for collecting the encrypted memory dump data from the secure memory region;
means for providing the encrypted memory dump data, without decrypting the encrypted memory dump data, to a third party for debugging purposes; and
means for rebooting the peripheral subsystem of the SoC device.

18. The apparatus of claim 17, further comprising:
means for sending a message to the means for encrypting containing instructions to encrypt the memory dump data in the secure memory region of the peripheral subsystem.

19. The apparatus of claim 17, wherein means for rebooting a peripheral subsystem includes: means for booting a primary boot image of peripheral software from a read only memory (ROM) of the peripheral subsystem.

20. The apparatus of claim 17, wherein means for detecting crash of the peripheral subsystem further include means for taking control over a power source and a clock source to the peripheral subsystem.

21. The apparatus of claim 17, wherein means for encrypting includes an encryption algorithm and a root key for encrypting peripheral data before allowing access to the secure memory region of the peripheral subsystem.

22. The apparatus of claim 17, wherein the peripheral subsystem includes one or more of a modem subsystem, a memory subsystem, video/graphics subsystem, audio subsystem, power management subsystem, security subsystem, and I/O subsystem.

23. A computer program product embedded in a non-transitory computer-readable storage medium, the computer-readable storage medium comprising computer-executable instructions for rebooting and debugging a peripheral subsystem of a system on a chip (SoC) device, the medium comprising:
a first set of codes for detecting crash of the peripheral subsystem;
a second set of codes for accessing a secure memory region of the peripheral subsystem containing memory dump data associated with the peripheral subsystem;
a third set of codes for encrypting the memory dump data in the secure memory region;
a fourth set of codes for allowing access to the secure memory region of the peripheral subsystem containing the encrypted memory dump data;
a fifth set of codes for collecting the encrypted memory dump data from the secure memory region;
a sixth set of codes for providing the encrypted memory dump data, without decrypting the encrypted memory dump data, to a third party for debugging purposes; and
a seventh set of codes for rebooting the peripheral subsystem of the SoC device.

24. The computer program product of claim 23, further comprising:
an eighth set of codes for sending a message instructing the third set of codes to encrypt the memory dump data in the secure memory region of the peripheral subsystem.

25. The computer program product of claim 23, wherein seventh set of codes includes a ninth set of codes for booting a primary boot image of peripheral software from a read only memory (ROM) of the peripheral subsystem.

26. The computer program product of claim 23, wherein the first set of codes further include a tenth set of codes for taking control over a power source and a clock source to the peripheral subsystem.

27. The computer program product of claim 23, wherein the sixth set of codes includes an encryption algorithm and a root key for encrypting peripheral data before allowing access to the secure memory region of the peripheral subsystem to the application processor.

28. The computer program product of claim 23, wherein the peripheral subsystem includes one or more of a modem subsystem, a memory subsystem, video/graphics subsystem, audio subsystem, power management subsystem, security subsystem, and I/O subsystem.
